(19) United States
(12) Patent Application Publication
(10) Pub. No.: US 2012/0166250 A1
(43) Pub. Date: Jun. 28, 2012

(54) DATA VISUALIZATION FOR TIME-BASED COHORTS

(75) Inventors: Daniel Ferrante, Redwood City, CA (US); Alexander Paul Schultz, San Francisco, CA (US)

(73) Assignee: Facebook, Inc., Palo Alto, CA (US)

(21) Appl. No.: 12/976,685

(22) Filed: Dec. 22, 2010

(51) Int. Cl. G06Q 10/00

(52) U.S. Cl. 705/7.29

(57) ABSTRACT

Methods, apparatuses and systems directed to generating heat maps that facilitate analysis of user activity. In particular embodiments, a heat map represents activity intensity of time-based cohort groups over time.

### TECHNICAL FIELD

The present disclosure generally relates to data analysis and visualization, and in particular, generating a heat map based on temporal information and user clusters.

### BACKGROUND

A heat map is a graphical representation of data where the values at any given intersection or data point on a two-dimensional graph are represented as colors or other graphical symbols. A heat map may be used an outliner-detection-visualization tool that can be performed on each specified unit for a large number of selected tags across many different time points. A heat map illustrates the anomaly-intensity and the direction of a ‘target observation.’ A heat map may also contain a visual illustration of alerts, and directs immediate attention to hot-spot sensor values.

Business intelligence (BI) is a business management term that refers to applications and technologies that are used to gather, provide access to, and analyze data and information about business operations. Business intelligence systems can help companies obtain more comprehensive knowledge of the factors affecting their business, such as metrics on sales, production, internal operations, and make better business decisions.

### SUMMARY

The present invention provides methods, apparatuses and systems directed to generating heat maps that facilitate analysis of user activity. In particular embodiments, a heat map represents activity intensity of time-based cohort groups over time. These and other features, aspects, and advantages of the disclosure are described in more detail below in the detailed description and in conjunction with the following figures.

### BRIEF DESCRIPTION OF THE DRAWINGS

FIG. 1 illustrates an example single cohort metric graph.

FIG. 2 is an example multiple cohort metric graph.

FIG. 3 illustrates a heat map representing cohorts.

FIGS. 4A-D show example data structure.

FIG. 4E is a flow chart illustrating an example method for generating a heat map.

FIG. 5 is a schematic diagram of a computer network environment, in which particular embodiments of the present invention may operate.

FIG. 6 is a functional block diagram illustrating an example network device hardware system architecture.

### DESCRIPTION OF EXAMPLE EMBODIMENT(S)

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Business intelligence (BI) is a business management term that refers to applications and technologies that are used to gather, provide access to, and analyze data and information about business operations. Business intelligence systems can help companies have a more comprehensive knowledge of the factors affecting their business (such as metrics on sales, production, and internal operations), spot trends, and make better business decisions. Business intelligence applications and technologies can enable organizations to make more informed business decisions, and provide a competitive advantage. For example, a company could use business intelligence applications or technologies to extrapolate information from indicators in the external environment and forecast the future trends in their sector. Business intelligence is used to improve the timeliness and quality of information and enable managers to better understand the position of their company in comparison to its competitors. Business intelligence applications and technologies can help companies analyze the following: changing trends in market share, changes in customer behavior and spending patterns, customers' preferences, company capabilities and market conditions. Business intelligence can be used to help analysts and managers determine which adjustments are most likely to affect trends.

Data visualization may be an aspect of business intelligence applications. Data visualization generally refers to the visual representation of data or information which has been abstracted in some schematic form, including attributes or variables for units of information. A heat map is one data visualization technique. It is a graphical representation of data where the values at any given point (represented, for example, as x- and y-coordinates) in a two-dimensional or three-dimensional surface are represented as colors, gray scale or other intensity values. In other words, the value at each point maps to a corresponding color, gray scale or other graphical encoding value (e.g., from black to blue to green to red to yellow and to white). The graphical encodings or indications provided by the different pixel color intensities and the overall visual representation of the data allow for assessments of various data along multiple axes. In monitoring and diagnostics, a heat map is highly useful and revolutionary for monitoring and diagnostics. A heat map illustrates the anomaly-intensity and the direction of a ‘target observation.’ Heat maps can also provide marketing opportunities on the fly with great accuracy across different time scales such as per second, minute, hour, day, and the like. The method, as embodied by the patent invention is particularly useful when applied to functional time-based cohorts.

To facilitate a view of temporal information for purposes of trend evaluation, a heat map can be generated in which a first axis corresponds to a grouping or cluster of users, and a second axis corresponds to units of time. In statistics and demography, a cohort is a member of a group that share one or more attributes in common, such as age, location, income level and the like. Cohorts may be tracked over periods of time in order to reveal trends and other aggregate behaviors. The graphical encoding at each point in the heat map may indicate a ratio or percentage of the users in each cluster that satisfy a set of criterion. The set of attributes that are used to define each cluster may also be time-based, such as the day an event associated with a user occurred (e.g., the date of first registration, the date a user first clicks on a given web page or ad, etc.). In this way, a viewer can monitor activities and trends between and across these cohort groups without using multiple two dimension graphs.

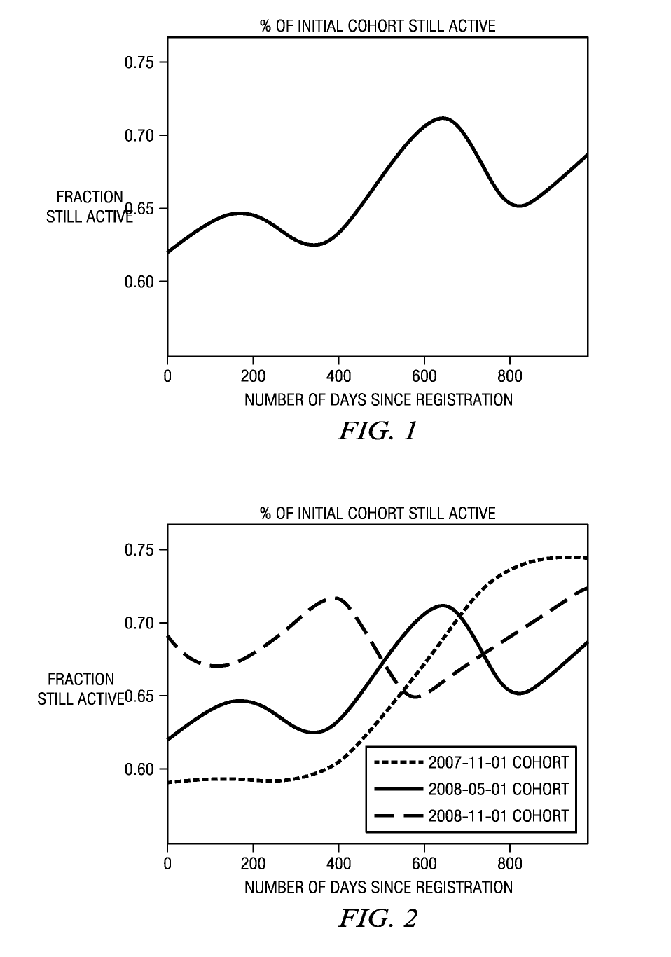

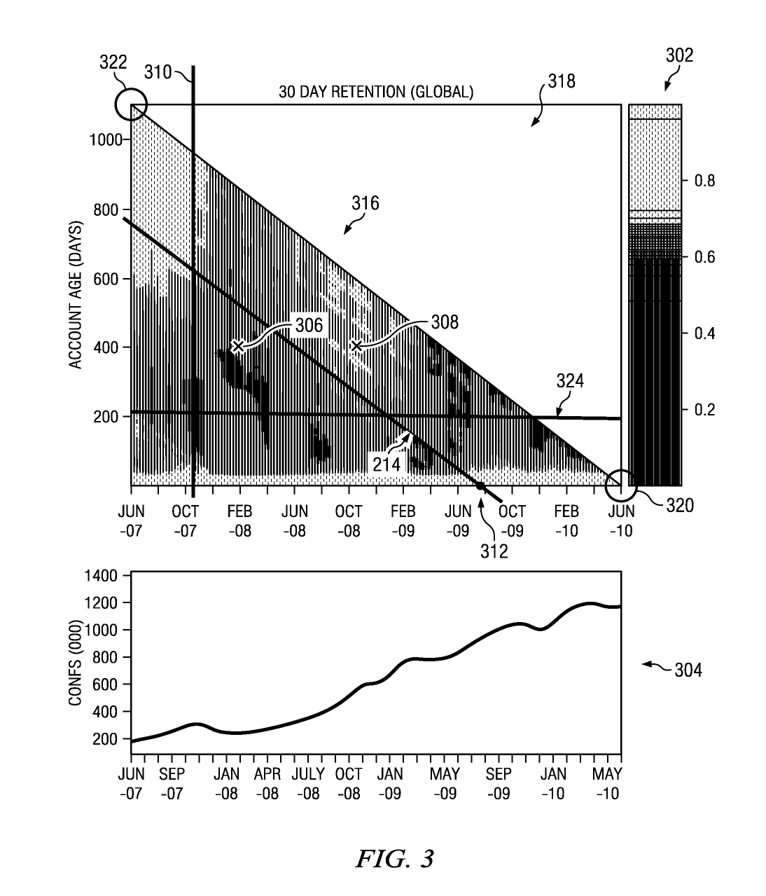

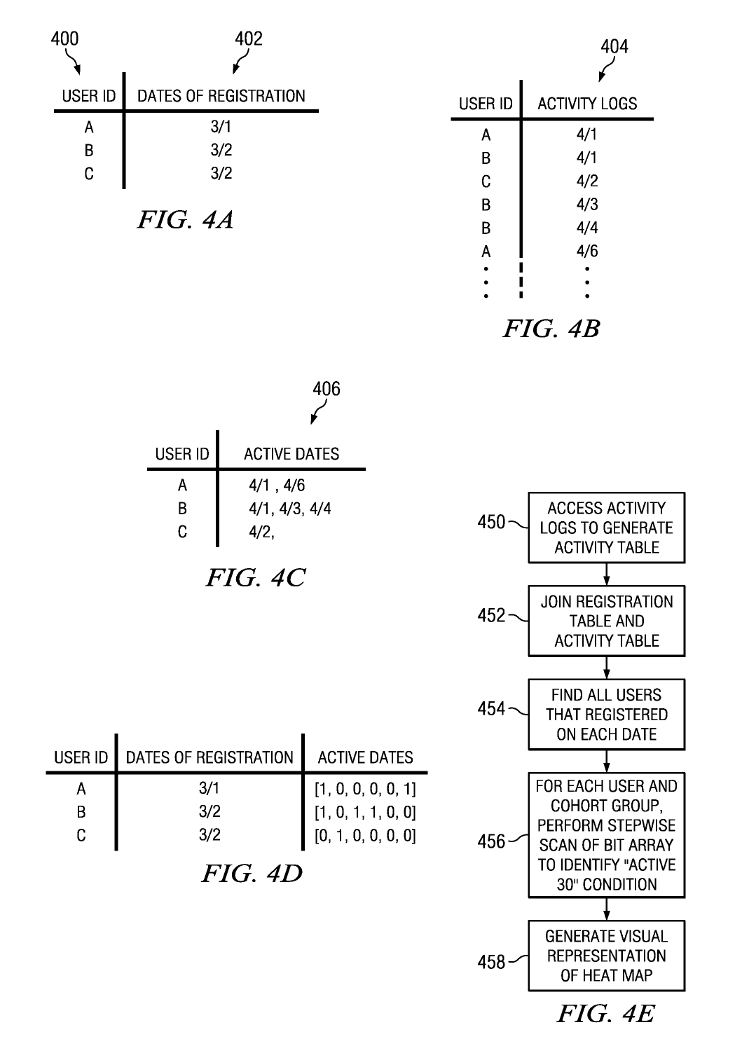

To analyze trends in some metric over time (such as the percentage of users from a given cohort group) that are sill active after a certain number of days since first registration, a graph with a function of one variable (see FIG. 1) may be used. Moreover, a graph like that illustrated in FIG. 2 can be used to analyze the trend not just as a function of user activity (such as number of days since first registration), but also a function of cohort group, plotting several time series to render multi-dimensional information. To analyze more cohort groups, the graph illustrated in FIG. 2 requires more lines to represent the activity of each cohort group, causing the graph to become difficult to read.

FIG. 3 illustrates an example heat map that may be generated in accordance with various implementations of the invention. In this heat map, each bin of the horizontal axis corresponds to a cohort group, where each cohort group is defined by a time-based criterion (such as date of registration). The vertical axis is a temporal axis where each bin represents a number of days from the time based criterion (here, date of first registration) that defines the cohort group. The graphical encoding (here, a color) at each intersection point in the heat map represents the percentage of users in a given cohort group that are active users (e.g., monthly active users (MAUs), daily active users (DAUs), and the like). A vertical slice of the heat map corresponds to one of the two-dimension lines illustrated in the FIG. 2. The heat map has a generally triangular shape due to the time-based nature of the cohort groups; that is, there is more data for users that registered prior to other users.

In FIG. 3, graphical encoding at point(x,y) shows, according to a gradient key 302 at right, the fraction of users that registered on day x that were Active-30—where Active 30 refers to detected activity within the last thirty days relative to day y. For example, the color at point (x=Feb. 1, 2008, y=400) 306 corresponds to gradient key 60%; therefore, 400 days later, at least 60% the users who registered on Feb. 1, 2008 306 qualify as “Active-30.” By contrast, the color at point (x=Oct. 15, 2008, y=400) 308 shows that 70% of another cohort group were “Active 30” after the same number of days since their registration. The color scale can be modified to adjust resolution at particular levels of retention. In this example, the gradient thresholds 302 are chosen so as to maximize differentiation throughout the triangle 316.

The line graph 304 under the heat map is a time series of the number of users in each cohort group—in one implementation, the number of users who confirmed their accounts on each day. The line graph 304 provides context for the volume of users in each cohort group. As discussed above, the triangle-shape of the plot 316 results because users in more recent cohort groups (increasing values of x) 320 have not been on the site long enough to provide data as y values 322 increase beyond the total number of days since a given cohort group first registered with the web site. In addition, the same calendar day for each cohort group along the y-axis is shifted by one day. Accordingly, the state of all cohort groups on a given day can be assessed by running a diagonal line 314.

The heat map of FIG. 3 reveals a vast amount of information and facilitates identification of a number of different trends and events. Furthermore, the heat map can be used as an engagement tracking tool for web site operators, advertisers, retailers and the like. Horizontal color patterns 324 represent attributes associated with a particular user tenure. From this data visualization, a web site operator may attempt to correlate any changes to the web site (e.g., new features or content) with the differences in user behavior.

Vertical color patterns 310 represent attributes associated with a particular cohort group. For example, the heat map reveals that the cohort groups corresponding to December 2007 to approximately April 2008 exhibited roughly similar activity patterns, while subsequent cohort groups behaved differently and remained more active. From the heat map, a user may also be able to discern diagonal color patterns or lines (upper-left to lower-right) 314 that represent a particular calendar date. For example, diagonally oriented lines or patterns can reveal events or trends that are observed across different cohort groups independent of tenure. Where such a diagonal line intersects the x-axis in the example heat map illustrated in FIG. 3, may identify a day of some form of event or other circumstance when an event occurred. For example, if there was an event on a given day (such as a new feature, content, promotion or service), user activity across all or many cohort groups may increase. Diagonal line 314 intersects the x-axis at day X 312 and reveals a change in user activity across several cohort groups, thereby generating the diagonal trend line. Upon visualizing the data in this manner, a website operator or marketer can correlate this trend with an event on or near day X and determine whether the event caused a brief spike in user activity or correlated to more meaningful user retention or activity. The events, for example, may be web site outages, new features, promotional events and the like.

To generate the graph above FIG. 3, any suitable data structure and functionality for creating the heat maps discussed above can be used. FIG. 4A-4D illustrate segments of example data tables that can be accessed and/or generated to create a heat map. FIG. 4E sets forth an example process for generating a heat map according to particular implementations of the invention. Firstly, FIG. 4A is a table that stores user identifiers 400 and dates of registration 402. FIG. 4B stores activity logs 404. In one implementation, the activity logs can be web logs that store logs of web-based or other requests transmitted from remote hosts associated with users. The activity logs may store in connection with each request, an IP address of the remote host, a request URL, a user identifier and a time stamp of the request. As FIG. 4E illustrates, a graph generating process may access the activity logs to generate an activity table (450), such as the activity table illustrated in FIG. 4C. The activity table, in one implementation, is a compacted version of the activity log in that each row of the table corresponds to a user and includes all dates that a user request associated with that user was logged. A typical web log may include multiple records for a given user in a given day. The heat map generation process creates only non-duplicative date entries in a given row.

The graph generating process may also join the registration table of FIG. 4A with the activity table of FIG. 4C (452). Prior to or after joining the tables, the heat map generating process may also convert the list of date entries in the activity table to a bit array, where each bit position represents a series of days with the origin (or first bit position) corresponding to the date of first registration. In one implementation, a “1” indicates detected activity, while a “0” indicates no date entry or detected activity for the day associated with that bit position in the array. FIG. 4D illustrates the results of the joining and conversion operations described above. The graph generation process may execute a set of search operations to generate various data values used in generating the heat map described above. For example, the graph generation process may access the combined table to find all users that registered on each date (454). These computed values can be used to generate the time series registration graph 304 and can be used as a denominator in percentage calculations associated with each time-based cohort group.

The graph generating process may, for each user and cohort group, perform a stepwise scan of the bit arrays for each entry to identify whether a user satisfies an “Active 30” condition (456). As discussed above, an Active 30 user is a user that, relative to day X, was active at least one day in the 30 days preceding day X. Accordingly, to detect whether a user satisfies this condition for a series of days, the graph generating process may use a 30 day or bit window. If there is at least one “1” value in the current window, the “Active 30” condition is satisfied for that day. The graph generating process may increment a counter value for that day and then advance the scan window by one bit position and repeat the evaluation until the end of the bit array is reached. As discussed above, this process is performed for all users and cohort groups. The graph generating process uses the resulting values to generate a visual representation of the heat map, such as that illustrated in FIG. 3. For example, for a given day Y (on the y-axis) and cohort group (on the x-axis), the graph generating process may divide the total number of Active 30 users by the total number of users in the cohort group and map the resulting value to a color or other graphical encoding value. In some implementations, the graph generating process may also analyze the data to locate diagonal, horizontal and/or vertical trend lines and generate diagonal, horizontal and/or vertical lines that highlight possible events on the heat map.

The implementation described above describes how cohort groups are based on dates of first registration and an evaluation of user activity against an active 30 condition. The invention has application to a wide variety of analysis scenarios. For example, cohort groups may be defined by other time-based criterion and events. For example, the time base criterion can be the date of any activity or event associated with a user, such as the day a user was first presented with (or first clicked on an URL corresponding to) an advertisement (or advertising campaign), the date a user first expressed interest in a given section of a web site or a particular page, the date a user first made a purchase in a physical retail or web-based store, the date a user first utilized a new feature of a web site, the date a user first opted-in to a service or promotion, and the like.

Furthermore, the evaluation of user activity can also vary considerably. For example, the user activity can be evaluated against an “Active 15”, Active 7 or “Daily Active” basis. Furthermore, the activities assessed can be generally defined as any activity associated with a web site or other entity, or specific activities (such as use of particular features, access of particular web pages, purchase activity and the like). Furthermore, the activity values at each intersection can also vary. In the implementation discussed above, each intersection point corresponds to a ratio or percentage of active users in a given cohort group. In other implementations, other types of activity can be quantified. For example, the values at each intersection point may represent the aggregate number of page views, the aggregate data bytes transferred, aggregate purchase amount activity and the like.

As described herein, the heat map-generating process can be implemented as a series of computer-readable instructions, embodied on a data storage medium, that when executed are operable to cause one or more processors to implement the operations described above. For smaller datasets, the operations described above can be executed on a single computing platform or node. For larger systems and resulting data sets, parallel computing platforms can be used. For example, the operations discussed above can be implemented using Hive to accomplish ad hoc querying, summarization and data analysis, as well as using as incorporating statistical modules by embedding mapper and reducer scripts, such as Python or PerI scripts that implement a statistical algorithm. For example, Fisher's exact test or other statistical algorithm can be implemented as a Python script, which as shown above can be called using a TRANSFORM clause. Other development platforms that can leverage Hadoop or other Map-Reduce execution engines can be used as well.

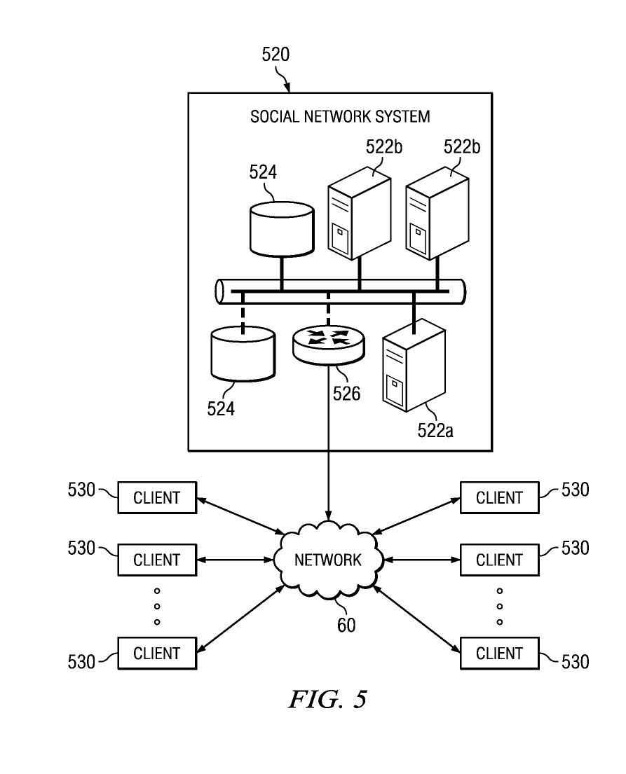

The Apache Software Foundation has developed a collection of programs called Hadoop (named after a toddler's stuffed elephant), which includes: (a) a distributed file system; and (b) an application programming interface (API) and corresponding implementation of MapReduce. FIG. 5 illustrates an example distributed computing system, consisting of one master server 522a and two slave servers 522b. In some embodiments of the present invention, the distributed computing system comprises a high-availability cluster of commodity servers in which the slave servers are typically called nodes. Though only two nodes are shown in FIG. 5, the number of nodes might well exceed a hundred, or even a thousand, in some embodiments. Ordinarily, nodes in a high-availability cluster are redundant, so that if one node crashes while performing a particular application, the cluster software can restart the application on one or more other nodes.

Multiple nodes also facilitate the parallel processing of large databases. In some embodiments of the present invention, a master server, such as 522a, receives a job from a client and then assigns tasks resulting from that job to slave servers or nodes, such as servers 522b, which do the actual work of executing the assigned tasks upon instruction from the master and which move data between tasks. In some embodiments, the client jobs will invoke Hadoop's MapReduce functionality, as discussed above.

Likewise, in some embodiments of the present invention, a master server, such as server 522a, governs a distributed file system that supports parallel processing of large databases. In particular, the master server 522a manages the file system's namespace and block mapping to nodes, as well as client access to files, which are actually stored on slave servers or nodes, such as servers 522b. In turn, in some embodiments, the slave servers do the actual work of executing read and write requests from clients and perform block creation, deletion, and replication upon instruction from the master server.

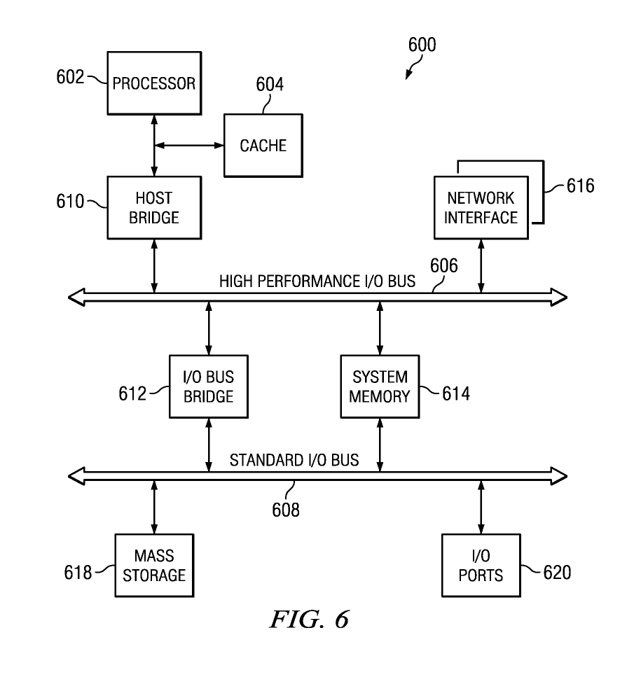

While the foregoing processes and mechanisms can be implemented by a wide variety of physical systems and in a wide variety of network and computing environments, the server or computing systems described below provide example computing system architectures for didactic, rather than limiting, purposes. FIG. 6 illustrates an example computing system architecture, which may be used to implement a server 522a, 522b. In one embodiment, hardware system 600 comprises a processor 602, a cache memory 604, and one or more executable modules and drivers, stored on a computer readable medium, directed to the functions described herein. Additionally, hardware system 600 includes a high performance input/output (I/O) bus 606 and a standard I/O bus 608. A host bridge 610 couples processor 602 to high performance I/O bus 606, whereas I/O bus bridge 612 couples the two buses 606 and 608 to each other. A system memory 614 and one or more network/communication interfaces 616 couple to bus 606. Hardware system 600 may further include video memory (not shown) and a display device coupled to the video memory. Mass storage 618, and I/O ports 620 couple to bus 608. Hardware system 600 may optionally include a keyboard and pointing device, and a display device (not shown) coupled to bus 608. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 600 are described in greater detail below. In particular, network interface 616 provides communication between hardware system 600 and any of a wide range of networks, such as an Ethernet (e.g., IEEE 802.3) network, a backplane, etc. Mass storage 618 provides permanent storage for the data and programming instructions to perform the above-described functions implemented in the servers 522a, 522b, whereas system memory 614 (e.g., DRAM) provides temporary storage for the data and programming instructions when executed by processor 602. I/O ports 620 are one or more serial and/or parallel communication ports that provide communication between additional peripheral devices, which may be coupled to hardware system 600.

Hardware system 600 may include a variety of system architectures; and various components of hardware system 600 may be rearranged. For example, cache 604 may be on-chip with processor 602. Alternatively, cache 604 and processor 602 may be packed together as a “processor module,” with processor 602 being referred to as the “processor core.” Furthermore, certain embodiments of the present invention may not require nor include all of the above components. For example, the peripheral devices shown coupled to standard I/O bus 608 may couple to high performance I/O bus 606. In addition, in some embodiments, only a single bus may exist, with the components of hardware system 600 being coupled to the single bus. Furthermore, hardware system 600 may include additional components, such as additional processors, storage devices, or memories.

In one implementation, the operations of the heat map generating process described herein are implemented as a series of executable modules run by hardware system 600, individually or collectively in a distributed computing environment. In a particular embodiment, a set of software modules and/or drivers implements a network communications protocol stack, parallel computing functions, heat map generating processes, and the like. The foregoing functional modules may be realized by hardware, executable modules stored on a computer readable medium, or a combination of both. For example, the functional modules may comprise a plurality or series of instructions to be executed by a processor in a hardware system, such as processor 602. Initially, the series of instructions may be stored on a storage device, such as mass storage 618. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communications interface 616. The instructions are copied from the storage device, such as mass storage 618, into memory 614 and then accessed and executed by processor 602.

An operating system manages and controls the operation of hardware system 600, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft (r) Windows(r) operating systems, BSD operating systems, and the like. Of course, other implementations are possible. For example, the heat map generating functions described herein may be implemented in firmware or on an application specific integrated circuit.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

The present invention has been explained with reference to specific embodiments. For example, while embodiments of the present invention have been described as operating in connection with a social network system, the present invention can be used in connection with any communications facility that allows for communication of messages between users, such as an email hosting site. In addition, while some embodiments have been described as analyzing wall posts, other message channel types, such as email, can also be considered in addition to, or in lieu of, wall posts. Still further, the heat map generating process described above can be made accessible to external systems via a set of application programming interfaces. Other embodiments will be evident to those of ordinary skill in the art. It is therefore not intended that the present invention be limited, except as indicated by the appended claims.

What is claimed is:

1. A method, comprising:
accessing a database of user information to define a plurality of cohort groups, each cohort group including one or more users and defined by a time-based condition;
accessing a data store of user activity data against the plurality of cohort groups and one or more criteria;
generating a data visualization interface comprising a heat map, the heat map having a first axis and a second axis, wherein each bin of the first axis corresponds to cohort group in the plurality of cohort groups, the user clusters ordered along the first axis based on a corresponding value of the time-based condition associated with the respective cohort group, wherein the second axis is a temporal axis, and wherein each intersection point in the graph is encoded to indicate a value derived from detected activity of the users in a corresponding cohort group.

2. The method of claim 1, wherein the value is a function of a first number of users that meet the one or more criteria and a second number of total users in a given cohort group.

3. The method of claim 1, wherein the time based condition is a time of registration.

4. The method of claim 1, wherein the time based condition is a time of first observed activity.

5. The method of claim 1 wherein the activity is purchase activity.

6. The method of claim 1 wherein the activity is accessing a web site.

7. An apparatus, comprising:
a memory;
one or more processors;
computer program code stored on a non-transitory medium comprising instructions operative to cause the one or more processors to:
access a database of user information to define a plurality of cohort groups, each cohort group including one or more users and defined by a time-based condition;
access a data store of user activity data against the plurality of cohort groups and one or more criteria;
generate a data visualization interface comprising a heat map, the heat map having a first axis and a second axis, wherein each bin of the first axis corresponds to cohort group in the plurality of cohort groups, the user clusters ordered along the first axis based on a corresponding value of the time-based condition associated with the respective cohort group, wherein the second axis is a temporal axis, and wherein each intersection point in the graph is encoded to indicate a value derived from detected activity of the users in a corresponding cohort group.

8. The apparatus of claim 7, wherein the value is a function of a first number of users that meet the one or more criteria and a second number of total users in a given cohort group.

9. The apparatus of claim 7, wherein the time based condition is a time of registration.

10. The apparatus of claim 7, wherein the time based condition is a time of first observed activity.

11. The apparatus of claim 7 wherein the activity is purchase activity.

12. The apparatus of claim 7 wherein the activity is accessing a web site.

13. A non-transitory, computer readable medium comprising computer program code encoded thereon, the computer program code comprising instructions operative, when executed, to cause one or more processors to:
access a database of user information to define a plurality of cohort groups, each cohort group including one or more users and defined by a time-based condition;
access a data store of user activity data against the plurality of cohort groups and one or more criteria;
generate a data visualization interface comprising a heat map, the heat map having a first axis and a second axis, wherein each bin of the first axis corresponds to cohort group in the plurality of cohort groups, the user clusters ordered along the first axis based on a corresponding value of the time-based condition associated with the respective cohort group, wherein the second axis is a temporal axis, and wherein each intersection point in the graph is encoded to indicate a value derived from detected activity of the users in a corresponding cohort group.

14. The computer readable medium of claim 13, wherein the value is a function of a first number of users that meet the one or more criteria and a second number of total users in a given cohort group.

15. The computer readable medium of claim 13, wherein the time based condition is a time of registration.

16. The computer readable medium of claim 13, wherein the time based condition is a time of first observed activity.

17. The computer readable medium of claim 13 wherein the activity is purchase activity.

18. The computer readable medium of claim 13 wherein the activity is accessing a web site.
